(19) United States
(12) Patent Application Publication
(10) Pub. No.: US 2005/0232418 A1
(43) Pub. Date: Oct. 20, 2005

(54) Method of distributing encrypted portions of an audiovisual programme

(76) Inventors: Philippe Bordes, Laille (FR); Philippe Guillotel, Vern Sur Seiche (FR); Edouard Francois, Bourg Des Comptes (FR)

Correspondence Address: THOMSON LICENSING INC., PATENT OPERATIONS, PO BOX 5312, PRINCETON, NJ, 08543-5312, US

(21) Appl. No.: 10/522,118

(22) PCT Filed: Jul. 18, 2003
(86) PCT No.: PCT/EP03/50319

§ 371 Date: Jan. 24, 2005

(30) Foreign Application Priority Data
Jul. 24, 2002 (FR) 0209361

(51) Int. Cl. H04N 7/167

(52) U.S. Cl. 380/200

(57) ABSTRACT

The method of distributing encrypted portions of an audiovisual programme to user terminals, in which the successive portions of the programme are encrypted with the aid of different keys, consists, on initiation, from a user terminal, of a telephone communication with a call centre, in transmitting in sequence from this call centre and during the telephone communication the keys to the user terminal, doing so in a manner synchronized with the distribution of the successive encrypted portions of the programme.

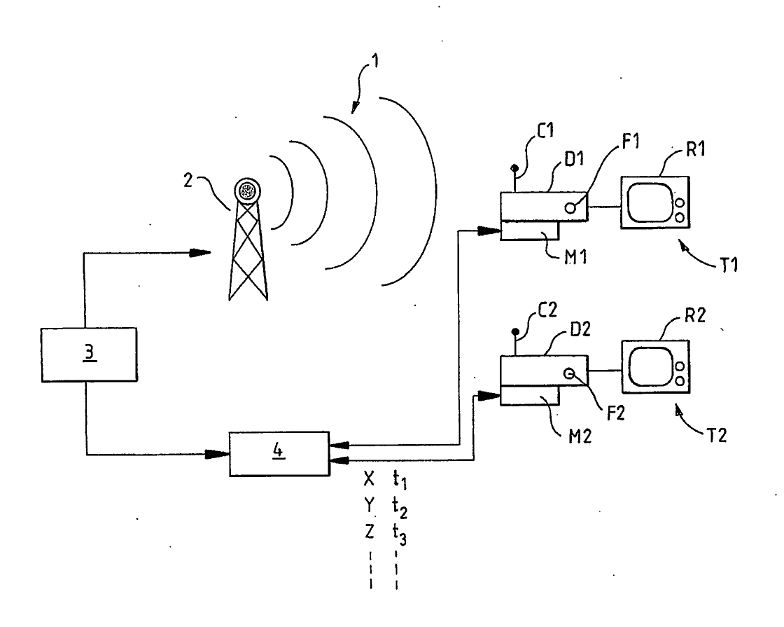

The invention relates to a method of distributing encrypted portions of an audiovisual programme to user terminals, in particular television receiver decoders, in which method the successive portions of the programme are encrypted with the aid of different keys before being distributed to the user terminals.

In the present patent application, the expression “audiovisual programme” designates any programme, possibly audio, video or both audio and video. Such a programme may in particular consist of a multimedia programme of MPEG 4 type which may contain for example several video and/or audio sequences, three-dimensional data, two-dimensional graphs and/or associated animation scripts.

A method of distributing encrypted portions is known from patent document EP-1075108. In this method, one or more seed values are communicated selectively to the user terminals so that they can locally regenerate a limited set of decryption keys making it possible to decrypt a corresponding limited number of encrypted portions of the programme. The communication of the seed values forms the subject of a billing to the user, the amount of which may vary as a function of the extent of the decryption. The billing may for example be on a per session or per subscription basis. A per subscription billing system proves to be complicated to set in place at the level of an audiovisual centre which provides the encrypted programmes. Moreover, per session billing gives rise to an overall increase in the cost to the user of using the audiovisual service in the case where he profits from only a fraction of the programme.

Furthermore, patent U.S. Pat. No. 4,916,737 discloses a technique in which scrambled video and/or audio portions are broadcast and are descrambled by means of a receiver decoder box. Moreover, a telephone modem linked with this box is periodically connected to a central computer of an operator, so as to receive a temporary identification code valid for the next period. This code is transmitted by the central computer only after recognition of a serial number specific to the relevant box. The periodicity of transmission of the new code is for example monthly and the connection lasts for only a few seconds, so that the telephone line need only be tied up for a very short duration and frequency.

This technique is suitable for an overall subscription for a given period and requires complicated management of the subscriptions. It does not allow billing adapted in a simple manner to the programmes actually viewed by a user.

U.S. Pat. No. 4,890,322 describes a service for distributing announcement messages which is used to control TV signals, programme by programme. The enciphered signals sent are deciphered at the level of each subscriber by a deciphering unit, by virtue of the use of a nondedicated telephone service line. With each order from a subscriber, the deciphering unit automatically transmits the subscriber's request to the distribution service via the telephone service line, and receives in return, via this same line, coded key information necessary for deciphering the desired programme. The key information obtained is used for the duration of the programme ordered. By way of example, the description mentions a deciphering key transmitted to the subscriber in the form of a message repeated for three seconds, this key being in the form of a number consisting of coded numerical values which may be used to fix the coefficients of a signal filter.

This method makes billing per programme possible without, however, allowing finer billing (for example to view a given part of a broadcast), while requiring complicated management of billing.

To improve the fineness of control on the part of users, provision may be made for the independent transmission of parts of programmes, each being able to form the subject of a specific request. Thus, depending on the availability thereof, a user may decide to view a first part of a film on a first evening, then a second part on another evening. However, such a solution yet further complicates the management of transmission and billing, all the more so the more elaborate the offerings—for example if they allow a viewer to choose the duration of each of the parts.

The invention proposes a method of distributing encrypted portions of an audio and/or video programme which permits simpler and finer billing of the service while being able to offer security against piracy.

The method according to the invention is characterized in that it consists, on initiation, from a user terminal, of a telephone communication with a call centre, in transmitting in sequence from this call centre and during the telephone communication the keys to the user terminal, doing so in a manner synchronized with the distribution of the successive encrypted portions of the programme. Of course, the distribution of the successive encrypted portions of the programme may be carried out by broadcasting over cable, by satellite or over the airwaves. The call centre is preferably a centre for receiving telephone calls of a telephone operator in which means exist for measuring, with each call of a user terminal, the time of the telephone communication therewith so that, on the basis of this information, an appropriate bill can be generated easily in respect of the corresponding user.

It is understood that, so long as the telephone communication is set up between the call centre and a user terminal, a decryption of the current portions of the programme is made possible locally in the user terminal. However, on completion of the telephone communication, the current encrypted portions of the programme are no longer decrypted since the keys no longer arrive at the user terminal. The duration of plaintext reception of the programme therefore corresponds overall to the duration of the telephone communication so that the user pays only in respect of the actual duration for which he profits from the audiovisual service.

The method of the invention contrasts surprisingly with the state of the art, in which one strives to reduce as far as possible the duration of telephone communication required to obtain the decryption data. Specifically, the method of the invention relies on the contrary on the continuity of the telephone communication throughout the distribution of the encrypted programme. These characteristics permit not only a broadcasting of audiovisual programmes for a duration decided exactly by the user in real time, but also a payment for this service directly by telephone billing.

The method according to the invention also advantageously exhibits the following features:
the telephone communication utilizes an Internet protocol;
synchronization time codes are transmitted in correspondence with the successive keys during the telephone communication.

The invention extends to a decoder for receiver of audio and/or video programmes, in which successive portions of a programme are decrypted with lo the aid of a succession of different keys, characterized in that it is designed to be connected up, by way of a telephone communication interface, to a call centre and to recover the successive keys in sequence during the communication with the call centre and to do so in a manner synchronized with the decryption of the successive portions of the programme.

According to preferred features of this decoder:
the telephone communication interface is a telephone modem in particular of the ADSL modem type which utilizes an Internet protocol.

The invention extends also to a decryption routine adapted for loading into the memory of a decoder for receiver of audio and/or video programmes having a telephone communication interface.

The method, the decoder and the routine according to the invention are described hereinbelow in greater detail and illustrated through the single FIGURE which diagrammatically represents a system for distributing pay video and/or audio programmes.

Represented in the FIGURE by way of nonlimiting example are just two user terminals T1, T2 each comprising a receiver R1, R2 of audio and/or video programmes, a decoder D1, D2 as well as a communication interface M1, M2 of the telephone modem type.

The receivers R1, R2 are here television receivers. The communication interfaces M1, M2 could form an integral part respectively of the decoders D1, D2 which may be decoders of the “set top box” type.

Each decoder D1, D2 is able to receive on an input channel C1, C2 successive encrypted portions of an audio and/or video programme. These programme portions are digital frames.

The encrypted portions of the programme are distributed here to the user terminals T1, T2 by the RF channel 1 from a broadcasting antenna 2 which is linked to an audiovisual centre 3 which provides the programme. In the audiovisual centre 3, the successive portions of the programme are encrypted using a succession of different encryption keys so as to limit the possibilities of piracy. The encryption key used to encrypt the successive portions of the programme is changed at the end of each sequence of n successive portions, the value of n being adjusted so as to have a different encryption key for example every 30 seconds of showing of the programme on the screen.

The use of time codes in digital audiovisual streams is known: DTS (Decoding Time Stamp), PTS (Presentation Time Stamp) and PCR (Programme Clock Reference) in MPEG2-TS streams. These time codes are inserted into each encrypted portion of the programme and make it possible to synchronize the decoder D1, D2 with the clock of the transmitter 3 of the audiovisual programme.

According to one aspect of the invention, time codes of the DTS type are associated during encryption in the audiovisual centre 3 with the various encryption keys. This association will serve during the decryption of the portions of the programme in a decoder to prevent the decryption of a portion of the programme if the time code associated with the decryption key provided for this portion of the programme is not synchronized with the time code DTS recovered in this portion of the programme.

The reference 4 in the FIGURE indicates a telephone call centre which receives in sequence from the audiovisual centre 3 the succession of encryption keys, doing so in a manner synchronized with the broadcasting of the successive portions of the programme by the antenna 2 and hence with the receiving in sequence of these portions of the programme by the user terminals T1, T2.

In order for the programme to be shown as plaintext at the level of the receiver R1, R2 of a user terminal T1, T2, the user operates his decoder D1, D2, decoder to initiate a telephone communication with the call centre 4 by way of a communication interface M1, M2 of the modem type. The call number of the call centre may be prerecorded in the decoder so as to make the opening of the telephone communication automatic. During the telephone communication, the decoder D1, D2 will be able to be identified by the call centre 4 and, following identification, the call centre 4 transmits in sequence via the telephone path to the user terminal T1, T2 the current successive keys serving for the decryption of the current portions of the programme received in parallel by the decoder D1, D2. The transmission in sequence by the call centre 4 of these keys each associated with a time code is done in a manner synchronized with the broadcasting of the portions of the programme by the antenna 2. In the FIGURE, “x, y, z, . . . ” represents the successive decryption keys and “t1, t2, t3, . . . ” represents the time codes associated with the decryption keys.

In each decoder D1, D2, the decryption procedure is organized in such a way that the successive keys together with the associated time codes recovered by way of the communication interface M1, M2 are checked by comparison with the DTS time codes located in the encrypted portions of the programme received by the decoder. Stated otherwise, a key associated with a time code t1 will be rejected if the programme portion received in parallel with the recovery of this key contains a DTS time code prior to t1. This programme portion will therefore not be decrypted in the decoder.

In practice, the successive keys together with the respective time codes are recovered in the user terminal with a slight lead with respect to the corresponding portions of programme and a temporary storage of the keys must therefore be organized in the decoder so as to allow the decryption during the reception of the current portion of programme. When a key together with a time code t1 is recovered by the decoder, it is stored in the temporary memory of the decoder if the DTS time code of the current portion of the programme is prior to the time code t1 associated with the key. In the converse case, the key is rejected and is therefore not recorded in the temporary memory of the decoder. During the decryption of a current portion of the programme, the key necessary for this

The decryption procedure hereinabove may be implemented by a routine loaded into memory in a conventional programmable decoder equipped with a telephone communication interface.

The communication interface will preferably be a modem of the ADSL type which will advantageously utilize an Internet communication protocol to allow multiple communications on the same telephone line.

1. Method of distributing encrypted portions of an audiovisual programme to user terminals, in which the successive portions of the programme are encrypted with the aid of different keys, wherein it consists, on initiation, from a user terminal, of a telephone communication with a call centre, in transmitting in sequence from this call centre and during the telephone communication the keys to the user terminal, doing so in a manner synchronized with the distribution of the successive encrypted portions of the programme.

2. Method according to claim 1, in which the telephone communication utilizes an Internet protocol.

3. Method according to claim 1, in which synchronization time codes are transmitted with the keys to the user terminal.

4. Method according to claim 1, in which, on completion of the telephone communication with a user terminal, a duration of telephone communication is determined in the call centre so as to draw up a bill corresponding to the reception of the programme by the user terminal.

5. Method according to claim 1, in which the call centre is a centre for receiving telephone calls of a telephone operator.

6. Decoder for receiver of audiovisual programmes, in which successive portions of a programme are decrypted with the aid of a succession of different keys, wherein it is designed to be connected up, by way of a telephone communication interface, to a call centre and to recover the successive keys in sequence during the communication with the call centre and to do so in a manner synchronized with the decryption of the successive portions of the programme,
the said decoder preferably being able to decrypt encrypted programme portions distributed according to a method in accordance with claim 1.

7. Decoder according to claim 6, designed to recover synchronization time codes from the call centre in association with the keys.

8. Decoder according to claim 6, in which the communication interface is a telephone modem.

9. Decoder according to claim 8, in which the communication interface is an ADSL modem.

10. Decoder according to claim 6, in which the communication interface utilizes an Internet protocol.

11. Method of decoding an audiovisual programme, according to which successive portions of the programme are decrypted with the aid of a succession of different keys, wherein it consists in connecting up, by way of a telephone communication interface, to a call centre so as to recover the successive keys in sequence during the communication with the call centre and to do so in a manner synchronized with the decryption of the successive portions of the programme
the said method preferably being intended to be implemented by means of a decoder in accordance with claim 6.

12. Decryption routine for decrypting successive portions of an audiovisual programme with the aid of a succession of different keys, wherein it is designed to set up a telephone communication with a call centre having a predefined call number and in that it is designed to recover the successive keys from the call centre during the telephone communication and to do so in a manner synchronized with the decryption of the successive portions of the programme,
the said routine preferably being intended to implement a decoding method in accordance with claim 11.
